(19) United States
(12) Patent Application Publication
(10) Pub. No.: US 2013/0279152 A1
(43) Pub. Date: Oct. 24, 2013

(54) TOUCH PANEL

(71) Applicant: LG INNOTEK CO., LTD., Seoul (KR)

(72) Inventor: Nicholas LEE, Seoul (KR)

(73) Assignee: LG INNOTEK CO., LTD., Seoul (KR)

(21) Appl. No.: 13/868,677

(22) Filed: Apr. 23, 2013

(30) Foreign Application Priority Data
Apr. 23, 2012 (KR) 10-2012-0041875

(51) Int. Cl. G02F 1/01

(52) U.S. Cl. CPC G02F 1/0105
USPC 362/97.1

(57) ABSTRACT

Disclosed is a touch panel. The touch panel includes a light source, a substrate on the light source, and a cover window formed on the substrate. A diffusion ink unit is formed on at least one surface of the substrate and the cover window by coating diffusion ink on the at least one surface of the substrate and the cover window.

### CROSS-REFERENCE TO RELATED APPLICATION

This application claims the benefit under 35 U.S.C. §119 of Korean Patent Application No. 10-2012-0041875, filed Apr. 23, 2012, which is hereby incorporated by reference in its entirety.

### BACKGROUND

A touch panel is installed on a display surface of an image display device including a cathode ray tube (CRT), a liquid crystal display (LCD), a field emission display (FED), a plasma display panel (PDP), or an electro-luminescence device (ELD), so that a user inputs predetermined information into a computer by pressing the touch panel while viewing the image display device.

The touch panel has a bonding structure including various layers. In general, the touch panel has a structure in which a cover window provided at the uppermost layer is bonded to a sensing electrode layer (ITO) having a single layer structure or a multi-layer structure, which is provided under the cover window, through an adhesive material (OCA).

FIG. 1 is a view showing a touch panel including a command icon region according to the related art.

FIG. 2 is a sectional view showing the command icon region of the touch panel according to the related art. In other words, FIG. 2 is a sectional view taken along line A-A′ of the touch panel shown in FIG. 1.

As shown in FIG. 1, the touch panel is additionally provided thereon with a command icon region 110, in which command icon patterns are additionally formed for the convenience of a user, to receive a command through a touch of the user.

In general, the command icon region 110 receives light from LEDs provided at the rear surface of the command icons, so that the user can easily distinguish among the command icons to input a command.

In more detail, as shown in FIG. 2, the command icon region 110 of the touch panel according to the related art includes an LED 120, a light guide film (LGF) 130, and a cover window 140.

The LGF 130 diffuses light output from the LED 120 through a diffusion ink unit, which is formed by coating diffusion ink on a PET film 131, which is separately provided, thereby allowing the light to be uniformly incident onto command icon patterns 111 formed in the cover window 140.

However, according to the related art, since the touch panel is constructed through a scheme of attaching the individual LGF 130 formed by coating the diffusion ink on the PET film, which is separately provided, the cost is incurred due to an additional process. In addition, since the precision is degraded in terms of shape matching, the definition of icon images may be degraded.

### BRIEF SUMMARY

According to the embodiment, there is provided a touch panel including a light source, a substrate on the light source, and a cover window formed on the substrate. A diffusion ink unit is formed on at least one surface of the substrate and the cover window by coating diffusion ink on the at least one surface of the substrate and the cover window.

### BRIEF DESCRIPTION OF THE DRAWINGS

FIG. 1 is a view showing a touch panel having a command icon region.

FIG. 2 is a sectional view showing the command icon region taken along line A-A′ of FIG. 1 according to the related art.

FIG. 3 is a sectional view showing the command icon region taken along line A-A′ of FIG. 1 according to the embodiment.

FIG. 4 is a view showing one surface of a cover window according to the embodiment.

FIGS. 5 and 6 are sectional views showing a command icon region of a touch panel taken along line A-A′ of FIG. 1 according to the first embodiment.

FIGS. 7 and 8 are views showing one surface of a substrate and a cover window according to the first embodiment.

FIGS. 9 and 10 are sectional views showing a command icon region of a touch panel taken along line A-A′ of FIG. 1 according to the second embodiment.

FIGS. 11 to 13 are views showing one surface of a substrate and a cover window according to the second embodiment.

FIGS. 14 and 15 are sectional views showing a command icon region of a touch panel taken along line A-A′ of FIG. 1 according to the third embodiment.

FIGS. 16 and 17 are views showing one surface of a substrate and a cover window according to the third embodiment.

FIG. 18 is a sectional view showing a command icon region of a touch panel taken along line A-A′ of FIG. 1 according to the fourth embodiment.

FIG. 19 is a view showing one surface of a cover window according to the fourth embodiment.

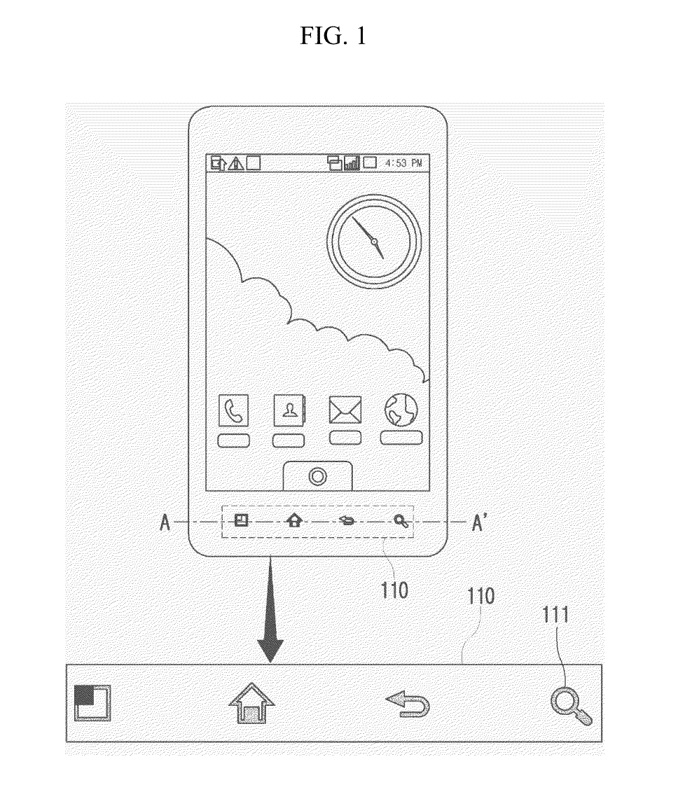

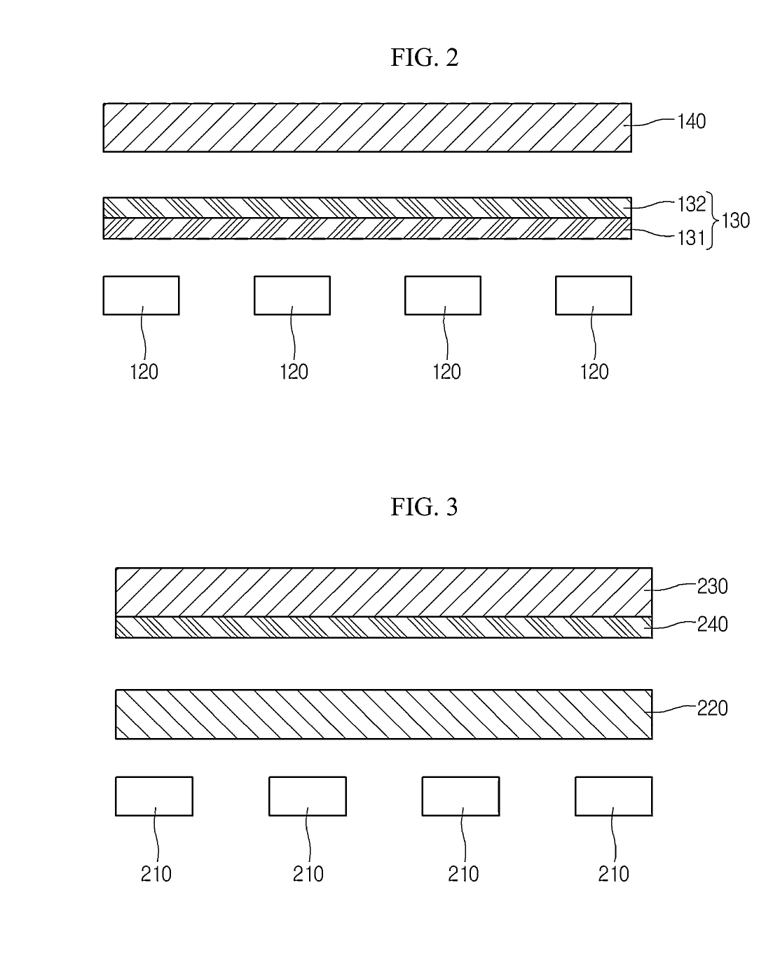

### DETAILED DESCRIPTION

Hereinafter, embodiments will be described in detail with reference to accompanying drawings. In the following description, when detailed description about well-known functions or configurations may make the subject matter of the disclosure unclear, the detailed description will be omitted. In addition, the size of the elements shown in the drawings may be exaggerated for the purpose of explanation and may not utterly reflect the actual size.

A touch panel according to the embodiment includes a light source 2, a substrate 220, a cover window 230, and a diffusion ink unit 240.

The light source 210 may output light to the cover window 230. In other words, the light source 210 may output the light toward the substrate 220 and the cover window 230, and the light may be incident into the cover window 230 through the substrate 220. For example, the light source 210 may include a light emitting diode (LED).

The substrate 220 is provided on the light source 210. The substrate 220 may be provided on one surface thereof or an opposite surface thereof with a sensing electrode or a diffusion ink unit. For example, the substrate 220 may include polyethylene terephthalate (PET). However, the substrate 220 may be omitted if necessary.

The substrate 220 is provided thereon with the cover window 230. The sensing electrode or the diffusion ink unit may be formed on one surface of the cover window 230. Preferably, the sensing electrode or the diffusion ink unit may be formed on one surface of the cover window 230 facing the substrate 220. The cover window 230 may include tempered glass, semi-tempered glass, soda-lime glass, and tempered plastic.

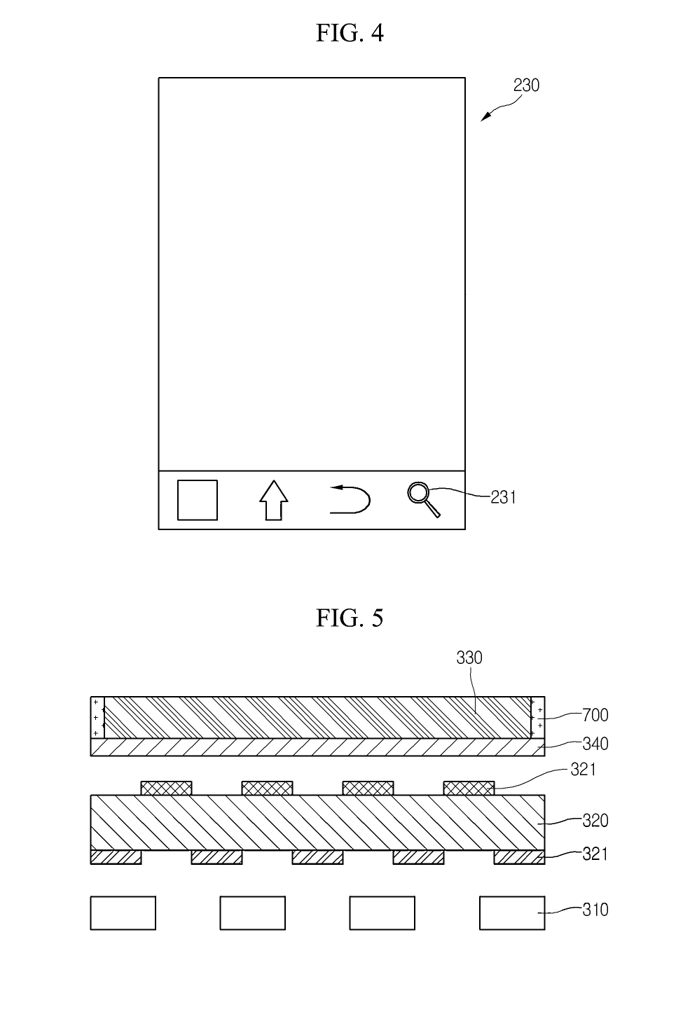

As shown in FIG. 4, command icon patterns 231 may be formed in the cover window 230. In detail, the command icon patterns 231 may be formed by forming and patterning a printing layer (not shown) between the cover window 230 and the substrate 220. The command icon patterns 231 allow a user to input a command at a region other than a main display unit for the convenience of the user.

The diffusion ink unit 240 is formed on at one surface of the substrate 220 and the cover window 230. In detail, the diffusion ink unit 240 may be formed on at least one surface of the substrate 220 and the cover window 230 by performing a coating process and a curing process with respect to the at least one surface of the substrate 220 and the cover window 230.

According to the related art, after a lighting guide film (LGF) is manufactured by applying a diffusion ink unit on a separate base such as a PET, the LGF is bonded onto a substrate. Therefore, a process is added so that the process cost is increased, and the process efficiency is reduced. The definition of the command icon patterns is degraded due to the failure in the bonding process.

However, according to the touch panel of the embodiment, diffusion ink is directly coated on at least one surface of a substrate or a cover window to form a diffusion ink unit, so that the processes can be reduced, and the problems derived from the bonding process can be solved.

Accordingly, the process efficiency can be improved, and the process cost can be reduced. In addition, since light output from a light source can be uniformly incident into command icon patterns through the diffusion ink unit, the brightness can be improved and the definition of the command icon patterns can be improved.

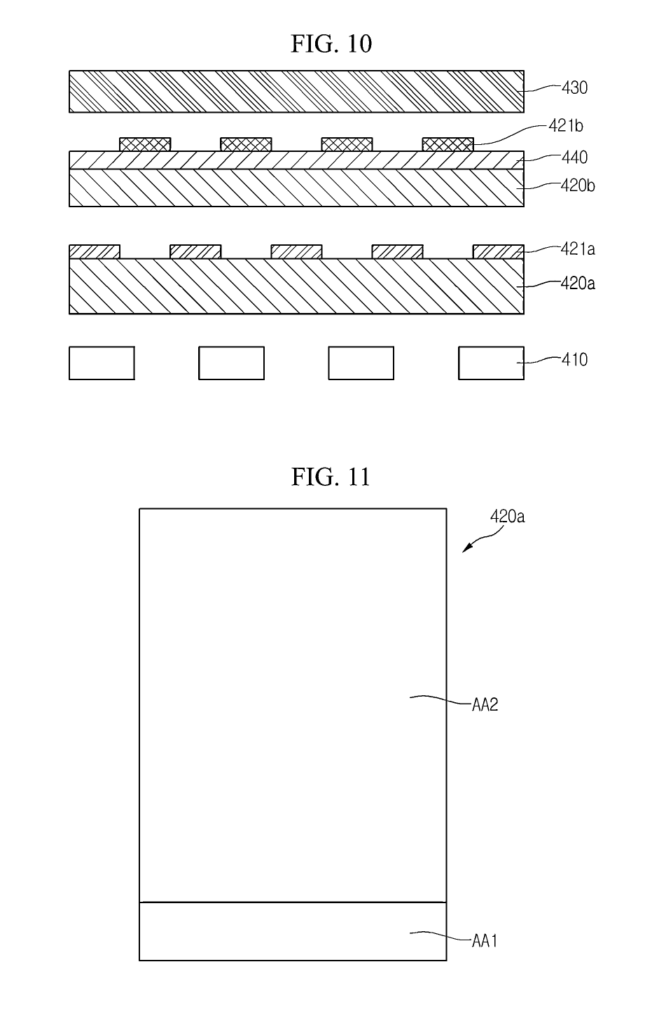

Hereinafter, touch panels according to various embodiments depending on positions in which the diffusion ink unit is formed will be described with reference to FIGS. 5 to 19.

First, hereinafter, a touch panel according to the first embodiment will be described with reference to FIGS. 5 to 8.

The touch panel according to the first embodiment includes a light source 310, a substrate 320, a cover window 330, and a diffusion ink unit 340.

As described above, the light source 310 includes a light emitting diode. The light source 310 may output light to the cover window 330.

As shown in FIG. 7, the substrate 320 may include a first active area AA1 and a second active area AA2. In addition, a sensing electrode 321 may be formed on one surface and an opposite surface of the substrate 320.

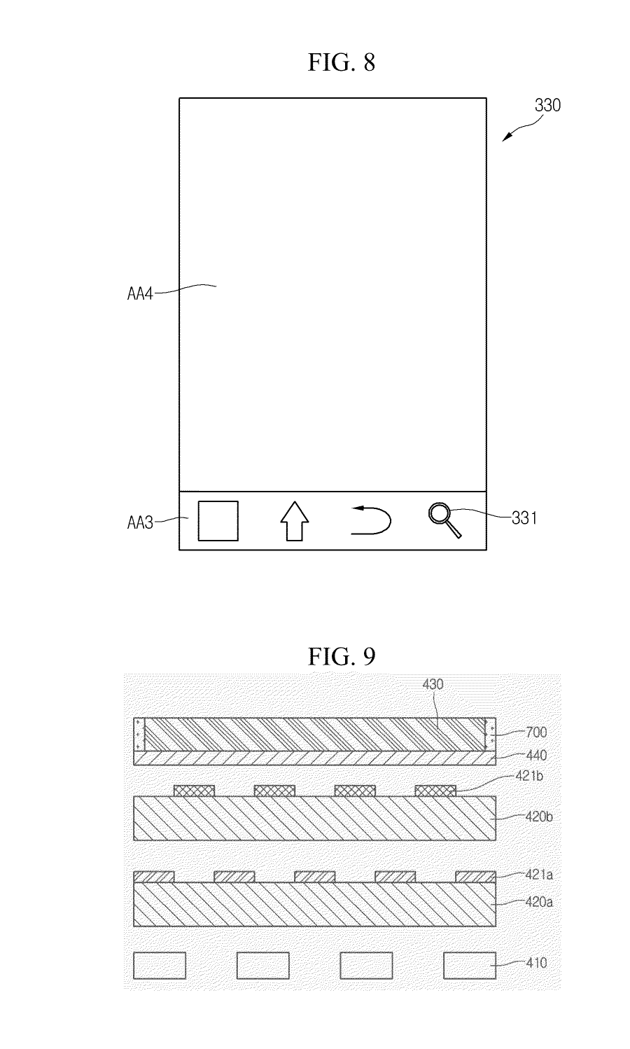

In addition, as shown in FIG. 8, the cover window 330 may include a third active area AA3 corresponding to the first active area AA1 and a fourth active area AA4 corresponding to the second active area AA2. In addition, command icon patterns 331 may be formed in the third active area AA3. Further, a main display region may be formed in the fourth active area AA4. In addition, light output from the light source 310 may be incident into the cover window 330.

The diffusion ink unit 340 may be formed on at least one of the first active area AA1 and the third active area AA3.

For example, as shown in FIG. 5, the diffusion ink unit 340 may be formed in the cover window 330. In detail, the diffusion ink unit 340 may be formed on one surface of the cover window 330 facing the substrate 320. In more detail, the diffusion ink unit 340 may be formed in the third active area AA3 of the one surface of the cover window 330 facing the substrate 320.

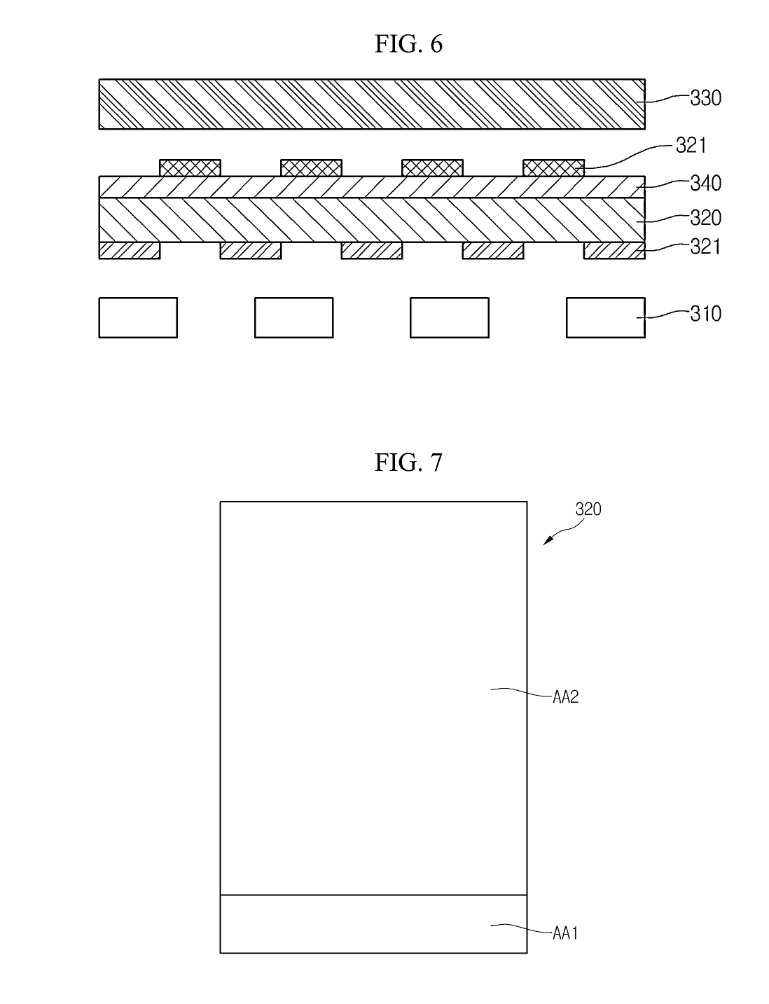

In addition, as shown in FIG. 6, the diffusion ink unit 340 may be formed on the substrate 320. In detail, the diffusion ink unit 340 may be formed on at least one of one surface and an opposite surface of the substrate 320 facing the cover window 330. In more detail, the diffusion ink unit 340 may be formed on the first active area AA1 provided in at least one of one surface and an opposite surface of the substrate 320 facing the cover window 330.

The diffusion ink unit 340 may be formed by coating diffusion ink on at least one surface of the first and third active areas and curing the diffusion ink by UV light or heat.

The diffusion ink unit 340 may be formed in the same shape as that of the command icon patterns. In addition, the diffusion ink unit 340 may be formed in the entire portion of the first active area AA1 and/or the third active area AA3 in which the command icon patterns are formed.

If the diffusion ink unit 340 is formed in the same shape as that of the command icon patterns, diffusion ink may be coated on a smaller area. Accordingly, an amount of diffusion ink can be minimized.

In addition, if the diffusion ink unit 340 is formed in the entire portion of the first active area AA1 and/or the third active area AA3, light can be diffused in larger quantity, so that the visibility of the command icon patterns can be improved.

In addition, a reflective layer 700 may be formed on at least one of lateral sides of the cover window 330 and the substrate 320. Accordingly, the reflective layer 700 reflects light to be diffused by the diffusion ink unit 340 and lost through the lateral side of the cover window 330 or the substrate 320, thereby reducing light loss, so that the brightness can be improved.

Hereinafter, a touch panel according to the second embodiment will be described with reference to FIGS. 9 to 13.

The touch panel according to the second embodiment includes a light source 410, a substrate, a cover window 430, and a diffusion ink unit 440.

As described above, the light source 410 includes a light emitting diode. The light source 410 may output light toward the cover window 430.

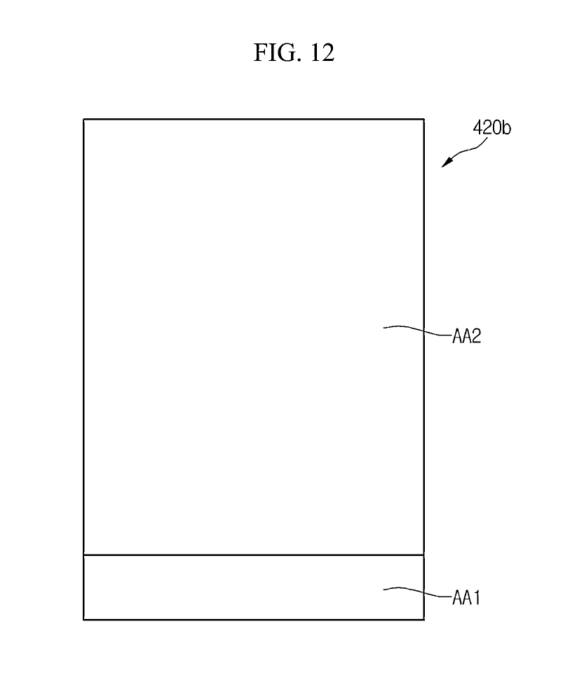

The substrate may include a first substrate 420a and a second substrate 420b provided on the first substrate 420a. As shown in FIGS. 11 and 12, the first and second substrates 420a and 420b may include first and second active areas AA1 and AA2. In addition, a first sensing electrode 421 may be formed on one surface or an opposite surface of the first substrate 420a. In addition, a second sensing electrode 421b may be formed on one surface or an opposite surface of the second substrate 420b.

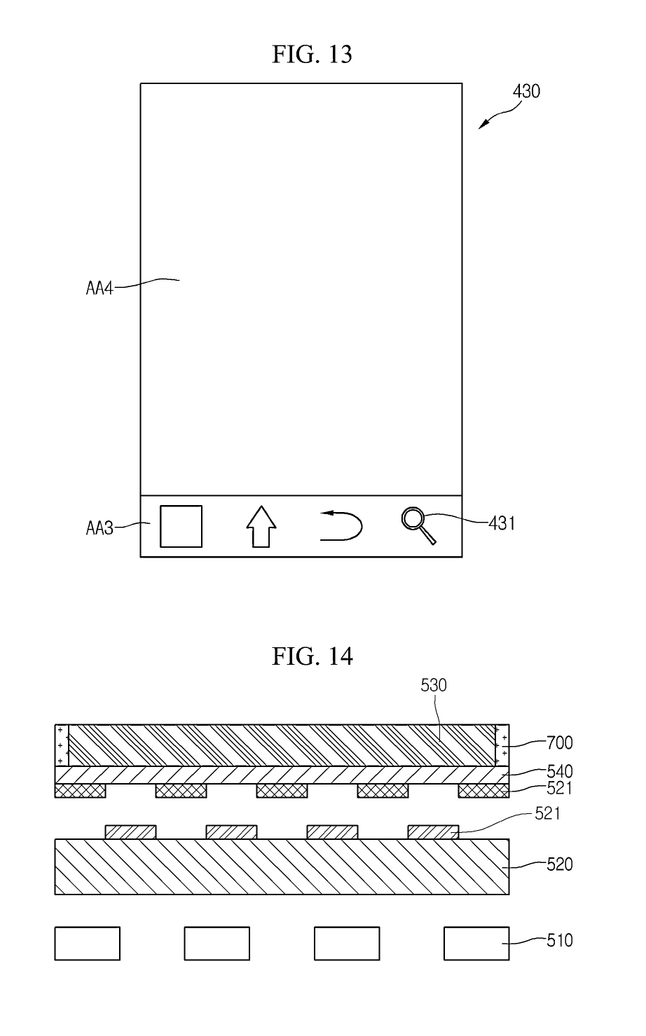

In addition, as shown in FIG. 13, the cover window 430 may include a third active area AA3 corresponding to the first active area AA1 and a fourth active area AA4 corresponding to the second active area AA2. In addition, command icon patterns 431 may be formed in the third active area AA3. In addition, a main display region may be formed in the fourth active area AA4. Further, the light output from the light source 410 may be incident into the cover window 430.

The diffusion ink unit 440 may be formed on at least one of the first active area AA1 and the third active area AA3.

For example, the diffusion ink unit 440 may be formed in the cover window 430. In detail, the diffusion ink unit 440 may be formed in one surface of the cover window 430 facing the second substrate 420b. In more detail, the diffusion ink unit 440 may be formed in the third active area AA3 of the one surface of the cover window 430 facing the second substrate 420b.

In addition, the diffusion ink unit 440 may be formed on at least one of the first and second substrates 420a and 420b. In detail, the diffusion ink unit 440 may be formed on at least one of the one surface and the opposite surface of the second substrate 420b facing the cover window 430. In detail, the diffusion ink unit 440 may be formed on the first active area AA1 provided in at least one of the one surface and the opposite surface of the second substrate 420b facing the cover window 430.

In addition, the diffusion ink unit 440 may be formed on at least one of one surface and an opposite surface of the first substrate 420a facing the second substrate 420b. In detail, the diffusion ink unit 440 may be formed on the first active area AA1 provided in at least one of one surface and an opposite surface of the first substrate 420a facing the second substrate 420b.

The diffusion ink unit 440 may be formed by coating diffusion ink on at least one surface of the first and third active areas AA1 and AA3 and curing the diffusion ink by UV light or heat.

The diffusion ink unit 440 may be formed in the same shape as that of the command icon patterns. In addition, the diffusion ink unit 440 may be formed in the entire portion of the first active area AA1 and/or the third active area AA3 in which the command icon patterns are formed.

If the diffusion ink unit 440 is formed in the same shape as that of the command icon patterns, diffusion ink may be coated on a smaller area. Accordingly, an amount of diffusion ink can be minimized.

In addition, if the diffusion ink unit 440 is formed in the entire portion of the first active area AA1 and/or the third active area AA3, light can be diffused in larger quantity, so that the visibility of the command icon patterns can be improved.

In addition, a reflective layer 700 may be formed on at least one of lateral sides of the cover window 430, and the first and second substrates 420a and 420b. Accordingly, the reflective layer 700 reflects light to be diffused by the diffusion ink unit 440 and lost through the lateral side of the cover window or the substrates, thereby reducing light loss, so that the brightness can be improved.

Hereinafter, a touch panel according to a third embodiment will be described with reference to FIGS. 14 to 17.

The touch panel according to the third embodiment includes a light source 510, a substrate 520, a cover window 530, and a diffusion ink unit 540.

As described above, the light source 510 includes a light emitting diode. The light source 510 may output light to the cover window 530.

As shown in FIG. 16, the substrate 520 may include first and second active areas AA1 and AA2. In addition, a sensing electrode 521 may be formed on at least one of one surface and an opposite surface of the substrate 520.

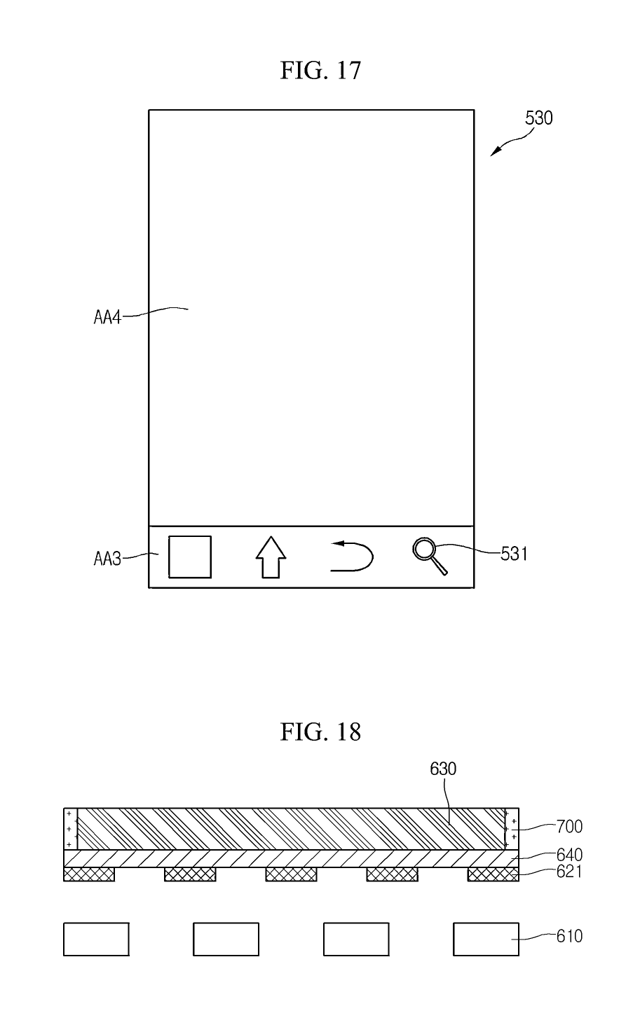

In addition, as shown in FIG. 17, the cover window 530 may include a third active area AA3 corresponding to the first active area AA1 and a fourth active area AA4 corresponding to the second active area AA2. In addition, command icon patterns 531 may be formed in the third active area AA3. In addition, a main display region may be formed in the fourth active area AA4. Further, the sensing electrode 521 may be formed on one surface of the cover window 530 facing the substrate 520. In addition, the light output from the light source 510 may be incident into the cover window 530.

The diffusion ink unit 540 may be formed on at least one of the first and third active areas AA1 and AA3.

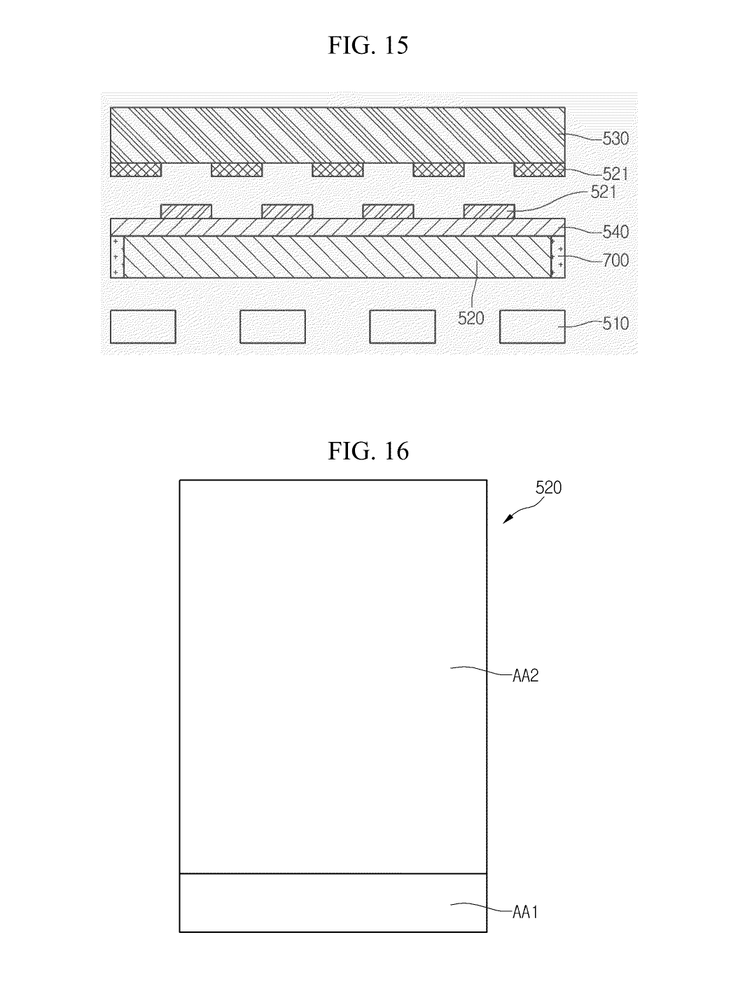

For example, as shown in FIG. 15, the diffusion ink unit 540 may be formed on the cover window 530. In detail, the diffusion ink unit 540 may be formed on one surface of the cover window 530 facing the substrate 520. In more detail, the diffusion ink unit 540 may be formed on the third active area AA3 provided in one surface of the cover window 530 facing the substrate 520.

In addition, as shown in FIG. 14, the diffusion ink unit 540 may be formed on the substrate 520. In detail, the diffusion ink unit 540 may be formed on at least one of one surface and an opposite surface of the substrate 520 facing the cover window 530. In more detail, the diffusion ink unit 540 may be formed on the first active area AA1 provided in at least one of one surface and an opposite surface of the substrate 520 facing the cover window 530.

The diffusion ink unit 540 may be formed by coating diffusion ink on at least one surface of the first and third active areas AA1 and AA3 and curing the diffusion ink by UV light or heat.

The diffusion ink unit 540 may be formed in the same shape as that of the command icon patterns. In addition, the diffusion ink unit 540 may be formed in the entire portion of the first active area AA1 and/or the third active area AA3 in which the command icon patterns are formed.

If the diffusion ink unit 540 is formed in the same shape as that of the command icon patterns, diffusion ink may be coated on a smaller area. Accordingly, an amount of diffusion ink can be minimized.

In addition, if the diffusion ink unit 340 is formed in the entire portion of the first active area AA1 and/or the third active area AA3, light can be diffused in larger quantity, so that the visibility of the command icon patterns can be improved.

In addition, a reflective layer 700 may be formed on at least one of lateral sides of the cover window 530 and the substrate 520. Accordingly, the reflective layer 700 reflects light to be diffused by the diffusion ink unit 540 and lost through the lateral side of the cover window 530 or the substrate 520, thereby reducing light loss, so that the brightness can be improved.

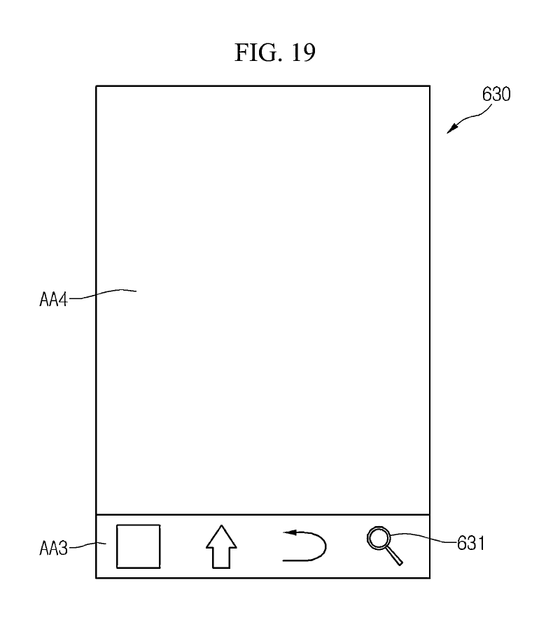

Hereinafter, a touch panel according to a fourth embodiment will be described with reference to FIGS. 18 and 19.

The touch panel according to the third embodiment includes a light source 610, a cover window 630, and a diffusion ink unit 640.

As described above, the light source 610 includes a light emitting diode. The light source 610 may output light to the cover window 630.

As shown in FIG. 19, the cover window 630 may include third and fourth active areas AA3 and AA4. In addition, command icon patterns 631 may be formed in the third active area AA3. In addition, a main display region may be formed in the fourth active area AA4. Further, a sensing electrode 621 may be formed on one surface of the cover window 630. In addition, the light output from the light source 610 may be incident into the cover window 630.

As shown in FIG. 18, the diffusion ink unit 640 may be formed on the third active area AA3. In more detail, the diffusion ink unit 640 may be formed on the third active area AA3 provided in the one surface of the cover window 630.

The diffusion ink unit 640 may be formed by coating diffusion ink on at least one surface of the third active area and curing the diffusion ink by UV light or heat.

The diffusion ink unit 640 may be formed in the same shape as that of the command icon patterns. In addition, the diffusion ink unit 640 may be formed in the entire portion of the third active area AA3 in which the command icon patterns are formed.

If the diffusion ink unit 640 is formed in the same shape as that of the command icon patterns, diffusion ink may be coated on a smaller area. Accordingly, an amount of diffusion ink can be minimized.

In addition, if the diffusion ink unit 640 is formed in the entire portion of the third active area AA3, light can be diffused in larger quantity, so that the visibility of the command icon patterns can be improved.

In addition, a reflective layer 700 may be formed on at least one of lateral sides of the cover window 630. Accordingly, the reflective layer 700 reflects light to be diffused by the diffusion ink unit 640 and lost through the lateral side of the cover window 630, thereby reducing light loss, so that the brightness can be improved.

According to the touch panels of the first to fourth embodiments, the diffusion ink unit can be formed by directly coating diffusion ink on one surface of a substrate or a cover window without separately preparing an LGF, so that the manufacturing cost can be reduced.

In addition, since the bonding process of the LGF is not required, problems derived from the failure in the bonding process are not caused.

In addition, since a base used to coat the diffusion ink can be omitted, the whole thickness of the touch panel can be reduced.

Further, a reflective layer is formed on a lateral side of the substrate or the cover window, thereby inhibiting the light diffused by the diffusion ink unit from being transmitted through the lateral side of the substrate or the cover window, so that the light loss can be reduced.

Therefore, according to the touch panel of the embodiment, the process cost can be reduced, and light can be more uniformly incident into the command icon patterns while representing higher brightness. The quality of the touch panel can be improved.

As described above, although various examples have been illustrated and described, the present disclosure is not limited to the above-mentioned examples and various modifications can be made by those skilled in the art without departing from the scope of the appended claims. In addition, these modified examples should not be appreciated separately from technical spirits or prospects.

What is claimed is:

1. A touch panel comprising:
a light source;
a substrate on the light source; and
a cover window on the substrate,
wherein a diffusion ink unit is formed on at least one surface of the substrate and the cover window.

2. The touch panel of claim 1, further comprising sensing electrodes formed on one surface of the substrate and an opposite surface of the substrate,
wherein the substrate comprises first and second active areas,
wherein the cover window comprises a third active area corresponding to the first active area and provided therein with a command icon pattern, and a fourth active area corresponding to the second active area, and
wherein the diffusion ink unit is formed on at least one of the first and third active areas.

3. The touch panel of claim 2, wherein the diffusion ink unit is formed on one surface of the cover window facing the substrate.

4. The touch panel of claim 2, wherein the diffusion ink unit is formed on at least one of one surface of the substrate facing the cover window and an opposite surface of the substrate.

5. The touch panel of claim 2, further comprising a reflective layer on at least one of lateral sides of the substrate and the cover window.

6. The touch panel of claim 2, further comprising a printed layer on the third active area of the cover window, wherein the command icon pattern is a printed pattern.

7. The touch panel of claim 2, wherein the diffusion ink unit is formed on an entire portion of at least one of the first and third active areas.

8. The touch panel of claim 2, wherein the diffusion ink unit is formed on a portion of at least one of the first and third active areas corresponding to a shape of the command icon pattern.

9. The touch panel of claim 1, wherein the substrate comprises a first substrate and a second substrate on the first substrate,
the first and second substrates comprise first and second active areas,
a first sensing electrode is formed on one surface of the first substrate or an opposite surface of the first substrate,
a second sensing electrode is formed on one surface of the second substrate or an opposite surface of the second substrate,
wherein the cover window comprises a third active area corresponding to the first active area and provided therein with a command icon pattern, and a fourth active area corresponding to the second active area, and
wherein the diffusion ink unit is formed on at least one of the first and third active areas.

10. The touch panel of claim 9, wherein the diffusion ink unit is formed on one surface of the cover window facing the second substrate.

11. The touch panel of claim 9, wherein the diffusion ink unit is formed on at least one of one surface of the first substrate facing the second substrate and an opposite surface of the first substrate.

12. The touch panel of claim 9, wherein the diffusion ink unit is formed on at least one of one surface of the second substrate facing the cover window and an opposite surface of the second substrate.

13. The touch panel of claim 9, further comprising a reflective layer on at least one of a lateral side of the first substrate, a lateral side of the second substrate, and a lateral side of the cover window.

14. The touch panel of claim 1, further comprising first sensing electrodes formed on at least one of one surface of the substrate and an opposite surface of the substrate, and second sensing electrodes formed on one surface of the cover window facing the substrate,
wherein the substrate comprises first and second active areas,
wherein the cover window comprises a third active area corresponding to the first active area and provided therein with a command icon pattern and a fourth active area corresponding to the second active area, and
the diffusion ink unit is formed on at least one of the first and third active areas.

15. The touch panel of claim 14, wherein the diffusion ink unit is formed on one surface of the cover window facing the substrate.

16. The touch panel of claim 14, wherein the diffusion ink unit is formed on at least one of one surface of the substrate facing the cover window and an opposite surface of the substrate.

17. The touch panel of claim 14, further comprising a reflective layer on at least one of a lateral side of the substrate and a lateral side of the cover window.

18. A touch panel comprising:
a light source; and
a cover window on the light source,
wherein the cover window comprises third and fourth active areas,
a sensing electrode is formed on one surface of the cover window, and
a diffusion ink unit is formed on the third active area.

19. The touch panel of claim 18, wherein a command icon pattern is formed on the third active area.

20. The touch panel of claim 18, further comprising a reflective layer on a lateral side of the cover window.
